(19) United States
(12) Patent Application Publication
(10) Pub. No.: US 2019/0316588 A1
(43) Pub. Date: Oct. 17, 2019

(54) MULTIFUNCTION ENGINE-DRIVEN GENERATOR SYSTEM

(71) Applicant: Lincoln Global, Inc., Santa Fe Springs, CA (US)

(72) Inventors: Justin M. Makosky, Hiram, OH (US); Edward A. Enyedy, Eastlake, OH (US); Adam M. Hruska, Chardon, OH (US)

(21) Appl. No.: 15/953,935

(22) Filed: Apr. 16, 2018

(51) Int. Cl. F04C 29/04; F04C 18/16; F04C 29/02; F04C 29/00; F02B 63/04; F02B 63/06; B23K 9/10

(52) U.S. Cl. CPC F04C 29/04; F04C 18/16; F04C 29/026; B23K 9/1006; F02B 63/047; F02B 63/06; F04C 29/0085

(57) ABSTRACT

A vehicle-mounted electric power generation system includes an engine-generator enclosure within which is an internal combustion engine, an electric generator coupled to the engine, and an air compressor driven by at least one of the engine and the generator. The system includes an air compressor system enclosure. At least one of an air compressor lubricating oil separator tank, an air compressor lubricating oil filter, an aftercooler, and a coalescing filter is located within the air compressor system enclosure. A compressed air conduit extends between the engine-generator enclosure and the air compressor system enclosure. The compressed air conduit conveys compressed air and air compressor lubricating oil from the air compressor. An air compressor lubricating oil conduit extends between the engine-generator enclosure and the air compressor system enclosure for supplying the air compressor lubricating oil to the air compressor.

### BACKGROUND OF THE INVENTION

### Field of the Invention

Embodiments of the present invention relate to engine-driven generator systems, and in particular to multifunction engine-driven generator systems that provide other types of power in addition to 50 Hz or 60 Hz electrical power. Such other types of power can include compressed air, welding current/voltage, battery charging power, and pressurized hydraulic fluid for example.

### Description of Related Art

Multifunction engine-driven generator systems include an engine, generator, and other devices such as an air compressor, air storage tank, and hydraulic pump located within a common enclosure. In an effort to provide a compact device having a small footprint, serviceability of various system components may be sacrificed. For example, access within the enclosure to belts, batteries, filters, brushes, spark plugs, etc., might be compromised or limited. Furthermore, cooling air in such multifunction systems might take a circuitous path within the common enclosure in order to effectively cool the various components of the system. Because the air must cool so many components, a high airflow is required, necessitating a large fan, which can create excessive noise. Moreover, complicated and costly ducting may be required to properly control the airflow.

### BRIEF SUMMARY OF THE INVENTION

The following summary presents a simplified summary in order to provide a basic understanding of some aspects of the devices, systems and/or methods discussed herein. This summary is not an extensive overview of the devices, systems and/or methods discussed herein. It is not intended to identify critical elements or to delineate the scope of such devices, systems and/or methods. Its sole purpose is to present some concepts in a simplified form as a prelude to the more detailed description that is presented later.

In accordance with one aspect of the present invention, provided is a vehicle-mounted electric power generation system. The system includes an engine-generator enclosure. An internal combustion engine is located within the engine-generator enclosure. An electric generator is located within the engine-generator enclosure and is coupled to the internal combustion engine and driven by the internal combustion engine. An air compressor is located within the engine-generator enclosure and is driven by at least one of the internal combustion engine and the electric generator. The system further includes an air compressor system enclosure, and at least one of an air compressor lubricating oil separator tank, an air compressor lubricating oil filter, an aftercooler, and a coalescing filter. Said at least one of the air compressor lubricating oil separator tank, the air compressor lubricating oil filter, the aftercooler, and the coalescing filter is located within the air compressor system enclosure. A compressed air conduit extends between the engine-generator enclosure and the air compressor system enclosure. The compressed air conduit conveys compressed air and air compressor lubricating oil from the air compressor. An air compressor lubricating oil conduit extends between the engine-generator enclosure and the air compressor system enclosure for supplying the air compressor lubricating oil to the air compressor.

In accordance with another aspect of the present invention, provided is a vehicle-mounted electric power generation system. The system includes an engine-generator enclosure. An internal combustion engine is located within the engine-generator enclosure. An electric generator is located within the engine-generator enclosure and is coupled to the internal combustion engine and driven by the internal combustion engine. An air compressor is located within the engine-generator enclosure and is driven by at least one of the internal combustion engine and the electric generator. The system further includes an air compressor system enclosure, an air compressor lubricating oil filter located within the air compressor system enclosure, and a coalescing filter located within the air compressor system enclosure. A compressed air conduit extends between the engine-generator enclosure and the air compressor system enclosure. The compressed air conduit conveys compressed air and air compressor lubricating oil from the air compressor. An air compressor lubricating oil conduit extends between the engine-generator enclosure and the air compressor system enclosure for supplying the air compressor lubricating oil to the air compressor.

In accordance with another aspect of the present invention, provided is a multifunction electric power generation system. The system includes an engine-generator enclosure supported by a chassis structure base. An internal combustion engine is located within the engine-generator enclosure. An electric generator is supported by the chassis structure base and is coupled to the internal combustion engine and driven by the internal combustion engine. An air compressor is supported by the chassis structure base and is driven by at least one of the internal combustion engine and the electric generator. A welding power supply is located within the engine-generator enclosure and is powered by the electric generator. The system further includes an air compressor system enclosure, an aftercooler located within the air compressor system enclosure, and an air compressor lubricating oil filter located within the air compressor system enclosure. A compressed air conduit extends between the engine-generator enclosure and the air compressor system enclosure. The compressed air conduit conveys compressed air and air compressor lubricating oil from the air compressor. An air compressor lubricating oil conduit extends between the engine-generator enclosure and the air compressor system enclosure for supplying the air compressor lubricating oil to the air compressor.

### BRIEF DESCRIPTION OF THE DRAWINGS

FIG. 1 is a perspective view of a vehicle-mounted electric power generation system;

FIG. 2 is a perspective view of an engine-generator;

FIG. 3 is a perspective view of an engine-generator and air compressor system;

FIG. 4 is a schematic block diagram; and

FIG. 5 is a perspective view of an engine-generator and water pump system.

### DETAILED DESCRIPTION OF THE INVENTION

Embodiments of the present invention relate to multifunction electric power generation systems, such as vehicle-mounted multifunction engine-driven generator systems. The present invention will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present invention. It may be evident, however, that the present invention can be practiced without these specific details. Additionally, other embodiments of the invention are possible and the invention is capable of being practiced and carried out in ways other than as described. The terminology and phraseology used in describing the invention is employed for the purpose of promoting an understanding of the invention and should not be taken as limiting.

Multifunction engine-driven generator systems provide both electrical power for loads such as tools and lights, and additional types of usable power such as compressed air, pressurized hydraulic fluid, welding current/voltage, battery charging capabilities, etc. The system includes an internal combustion engine, such as a diesel, gasoline or liquefied petroleum gas (LPG) engine. The engine drives a generator, which could be a synchronous 3-phase alternator, a single phase alternator, or a DC generator for example. The generator can have a number of stator windings for generating both electrical power dedicated for a specific use, such as welding, and 50 Hz or 60 Hz power for auxiliary loads operating at standard utility voltage levels (e.g., 120V, 240V, etc.) Additional power sources or accessories, such as an air compressor or hydraulic pump, can be driven directly by the engine or by the generator via a motor. If driven directly by the engine, the system can include clutches to selectively engage and disengage the compressors, pumps, etc.

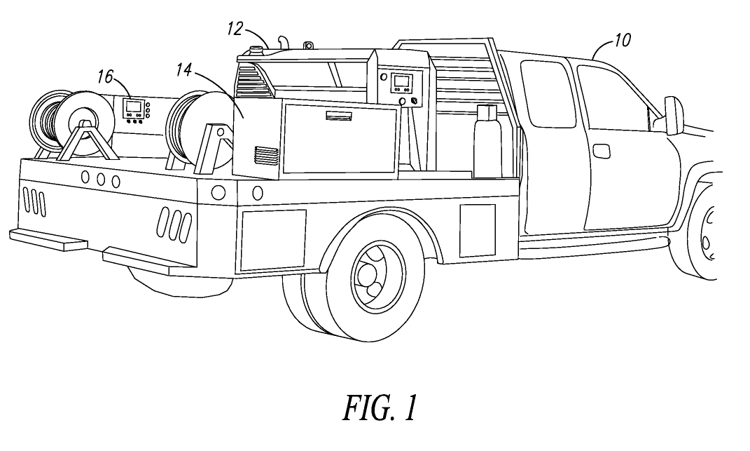

Turning to FIG. 1, the multifunction engine-driven generator system can be mounted to a vehicle, such as a truck 10, to provide a mobile power station. The engine and generator are mounted within an engine-generator enclosure 12. Additional power sources, such as a welding power supply, air compressor, or hydraulic pump for example, can also be mounted within the engine-generator enclosure 12. However, some system components are mounted in a separate enclosure 14 to improve the serviceability and/or cooling of the engine-generator and also the components mounted in the separate enclosure. It can be desirable to locate system components requiring regular service or inspection, or requiring heat removal, away from the engine-generator enclosure and placing them within the separate enclosure 14. Locating components requiring heat removal in the separate enclosure 14 eliminates the need for an engine fan to cool such components, which can reduce the size of the engine fan and allow it to operate more quietly.

For ease of explanation, the separate enclosure will be referred to as an air compressor system enclosure 14 that houses components of an air compressor subsystem. However, it is to be appreciated that the air compressor system enclosure 14 can include system components unrelated to an air compressor system, such as hydraulic fluid filters or fittings for example.

The vehicle-mounted electric power generation system can also include a user interface 16 that is separate from the engine-generator enclosure 12 and the air compressor system enclosure 14. The user interface 16 can be mounted at an accessible location on the vehicle 10 and allows an operator to control and/or monitor operations of the power generation system. Some example functions that can be provided through the user interface 16 include engine start/stop, fuel level monitoring and operation hours indication, air compressor activation, air pressure display, hydraulic pump activation, hydraulic pressure display, water pump activation, welding cable connections, welding mode selection, welding controls (e.g., voltage, amperage, etc.), welding voltage and current display, fault indicator lights, and the like. Additional user controls, inputs and outputs could be provided at the user interface 16.

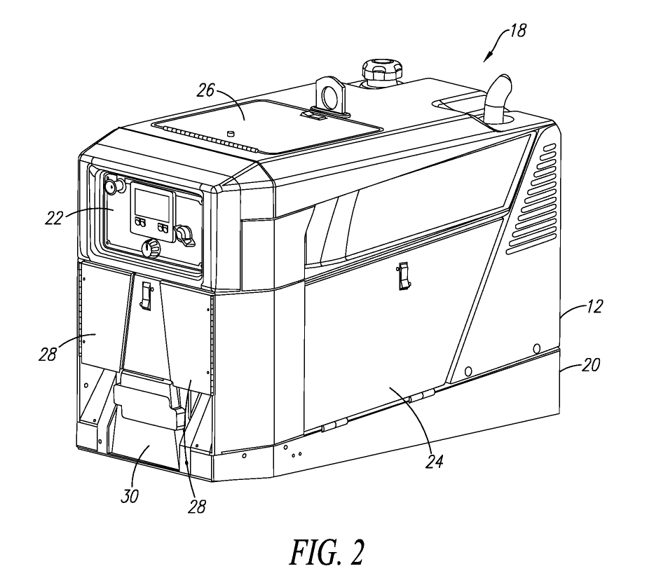

FIG. 2 is an outer perspective view of an example engine-generator. The engine-generator will be described in the context of a welding machine 18. However, it will be appreciated that aspects of the present disclosure are not limited to welding machines and would be applicable to other types of electrical power generation devices, such as standby generators, engine driven plasma cutters, hybrid power systems, and the like. The following description will proceed with reference to a welding machine, but this should not be viewed as limiting. The use of the terms welding and cutting is for sake of simplicity and should be understood to include welding, cutting, heating, hardfacing, soldering and brazing.

The welding machine 18 can include a base 20 that is part of a chassis structure for the welding machine, and an outer case or engine-generator enclosure 12. A local user interface 22 for controlling the operation of the welding machine 18 is located on the front side of the outer case 12. Example welding processes that can be performed by the welding machine include shielded metal arc welding (SMAW), gas metal arc welding (GMAW), flux-cored arc welding (FCAW), gas tungsten arc welding (GTAW), and gouging.

The case 12 can include various access doors. For example, doors 24 along the left and right lateral sides of the welding machine 18 can provide access to an engine compartment. In certain embodiments, the doors 24 are hinged at their bottom edges, allowing the doors 24 to swing downward. The doors 24 can be easily removable from the hinges, so that they can be relocated away from the welding machine 18 when accessing the engine compartment. A door 26 on the top of the welding machine 18 also provides access to the engine compartment. The top door 26 can be aligned with an air filter housing for the engine, so that the air filter can be readily inspected and replaced.

One or more doors 28 on the front side of the welding machine 18 can provide access to various electrical outputs of the welding machine. For example, GFCI auxiliary power receptacles and welding torch connections can be accessed via the doors 28 on the front of the welding machine 18. Beneath the doors 28 on the front side of the welding machine 18 is a removable battery compartment cover 30. A starting battery for starting the engine is stored in the battery compartment. The battery compartment is located at the front of the welding machine 18, and the starting battery is readily accessible directly from the front of the welding machine 18 by removing the cover 30, allowing the battery to be serviced (e.g., charged) or replaced.

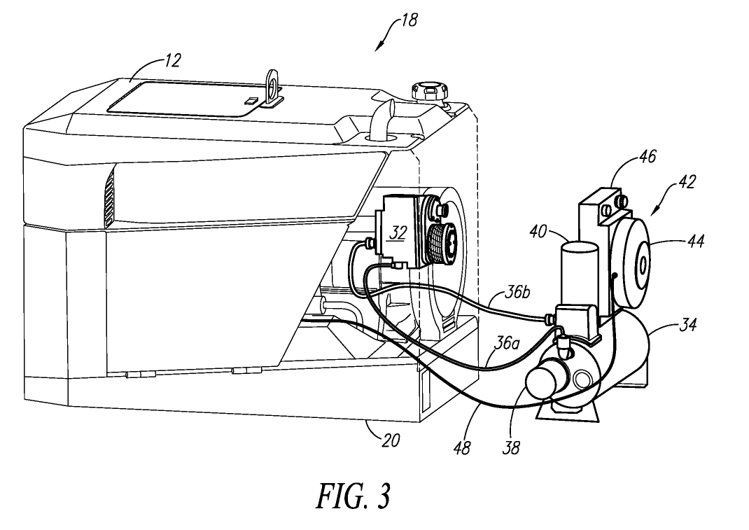

FIG. 3 shows the welding machine 18 with an air compressor 32 located within the engine-generator enclosure 12. Example air compressors 32 include rotary screw compressors, piston compressors, vane compressors, and the like. The air compressor system could include an air tank (not shown) if desired. However, a rotary screw compressor can provide high volumes of compressed air continuously and on demand. Thus, an air tank may not be needed if a rotary screw compressor is used. The air compressor 32 can be directly driven by the engine, such as via a belt and pulley system. The drive system for the air compressor 32 can include a clutch (e.g., an electromagnetic clutch) that controls the application of torque to the air compressor, to selectively activate and deactivate the air compressor. Alternatively, the air compressor 32 can be driven by an electric motor that is powered by the generator.

It can be seen in FIG. 3 that the generator and air compressor 32 can be located within the engine-generator enclosure 12. However, the engine-generator enclosure 12 need not enclose all of the components located at the welding machine 18, and some components could be exposed to ambient conditions if suitably weather resistant. For example, a portion of the air compressor 32 or generator could be located outside of the engine-generator enclosure 12 if desired. The chassis structure base 20 (FIG. 2) could be extended rearward for example, to support system components outside of the engine-generator enclosure.

The air compressor system enclosure discussed above is not shown in FIG. 3, but various components of the air compressor system that can be located within the air compressor system enclosure are shown. If the air compressor 32 is a rotary screw compressor, it can utilize lubricating oil that is injected into the compressor to lubricate and seal the compressor screws (e.g., male and female rotors), and to cool the compressor. The lubricating oil is stored in a lubricating oil separator tank 34. The separator tank 34 can be located in the air compressor system enclosure, remote from the engine-generator. Compressed air from the air compressor is mixed with the lubricating oil. The mixture of compressed air and lubricating oil flows from the air compressor 32 into the separator tank 34. The velocity of the compressed air is reduced within the separator tank 34. The majority of the lubricating oil that is mixed with the compressed air drops to the bottom of the separator tank by gravity. Locating the separator tank 34 in the air compressor system enclosure can facilitate periodic lubricating oil changes and adding additional oil when necessary.

The separator tank 34 can function as an oil reservoir for the air compressor 32, and the lubricating oil can be recirculated from the separator tank 34 to the air compressor 32. Supply and return lines 36a, 36b or conduits extend between the engine-generator enclosure 12 and the air compressor system enclosure to convey the lubricating oil and compressed air between the air compressor 32 and the separator tank 34. The recirculated lubricating oil is filtered by an oil filter 38 before being injected into the air compressor 32. The oil filter 38 should be replaced periodically, and locating the oil filter in the air compressor system enclosure can make the oil filter readily accessible for such maintenance. The oil filter 38 can be mounted to the separator tank 34 as shown or mounted elsewhere, such as on a filter manifold within the air compressor system enclosure.

The air compressor system can include a coalescing filter 40 located within the air compressor system enclosure. The coalescing filter 40 removes additional lubricating oil particles from the compressed air via a membrane material. The lubricating oil removed by the coalescing filter 40 can be returned to the separator tank 34 or to the air compressor 32 via an oil scavenge line that extends between the coalescing filter and the air compressor 32.

The air compressor system can further include an aftercooler 42. The aftercooler 42 has a fan 44 and heat exchangers 46 for cooling the lubricating oil and/or the compressed air. The lubricating oil can be cooled prior to recirculation to the air compressor 32. The aftercooler fan 42 can be powered by the generator. A wiring harness 48 having power conductors can extend between the engine-generator enclosure 12 and the air compressor system enclosure to provide power to the fan 42 and any other components in the air compressor system enclosure requiring electrical power. Control signals can also be communicated between engine-generator enclosure and the air compressor system enclosure via the wiring harness 48, such as a fan activation signal for example. The air compressor system enclosure can include venting to provide ambient cooling air to the fan 44 for cooling the heat exchangers 46.

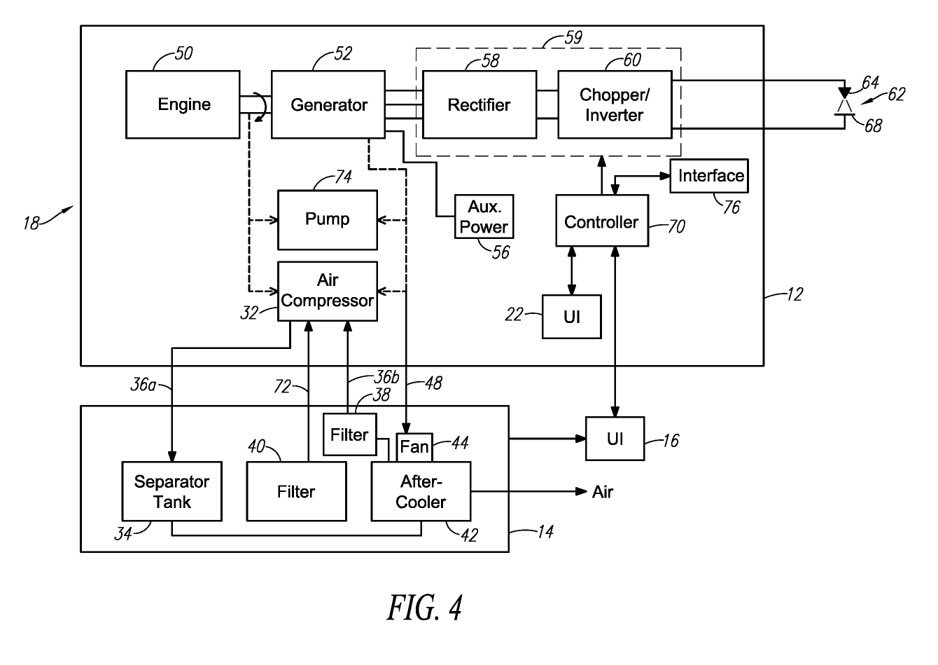

FIG. 4 is a schematic block diagram of the vehicle-mounted electric power generation system discussed above. The engine-generator enclosure 12 and air compressor system enclosure 14 are shown, along with example system components that can be located within these enclosures. The engine 50 drives the generator 52 to rotate and generate electrical power. As noted above, the generator 52 can include multiple stator windings for generating both electrical power for welding and power for auxiliary loads. In FIG. 4, the generator 52 supplies electrical power to both a welding power supply 54 and to an auxiliary power output 56. The welding power supply 54 can employ a switching type power converter. Example switching type power converters include DC choppers, inverters, and the like. AC power from the generator 52 is rectified by a rectifier 58 of the welding power supply 54. The DC output from the rectifier 58 supplies a DC bus of the welding power supply. The DC bus, in turn, supplies electrical power to a switching circuit, such as chopper or inverter 60. A welding operation is schematically shown in FIG. 4 as an electric arc 62 extending between a welding electrode 64 (consumable or non-consumable) and a workpiece 68. In certain embodiments, the welding machine 18 can be a hybrid powered machine having one or more batteries for providing electrical power to the welding power supply 54 and/or the auxiliary power output 56.

The welding machine 18 includes a controller 70 that is operatively connected to the welding power supply 54 for controlling the welding waveforms generated by the power supply. The controller 70 can provide a waveform control signal to the chopper/inverter 60 to control its output so as to generate the welding waveforms. The controller 70 controls the output of the chopper/inverter 60 via a waveform control signal, to achieve a desired welding waveform, welding voltage, welding current, etc. The waveform control signal can comprise a plurality of separate control signals for controlling the operation of various switches (e.g., transistor switches) within the chopper/inverter 60. The controller 70 can be an electronic controller and may include a processor. The controller 70 can include one or more of a microprocessor, a microcontroller, a digital signal processor (DSP), an application specific integrated circuit (ASIC), a field-programmable gate array (FPGA), discrete logic circuitry, or the like. The controller 70 can include memory portions (e.g., RAM or ROM) storing program instructions that cause the controller to provide the functionality ascribed to it herein. The controller 70 can include a plurality of physically separate circuits or electronic devices, such as a processor in combination with separate comparators, logic circuits, etc. However, for ease of explanation, the controller 70 is shown as a monolithic device.

The welding machine 18 can include a local user interface 22 that is operatively connected to communicate with the controller 70. Status information, such as a currently selected welding mode and other welding parameters, air pressure, hydraulic pressure, etc. can be displayed on the local user interface 22. Various operational parameters, such as welding voltage and current for example, can be set through the user interface 22. The controller 70 can also be operatively connected to communicate with the remote user interface 16 that is mounted separate from the engine-generator enclosure 12. The remote user interface 16 can be operatively connected to components in the air compressor system enclosure 14, to control or display information related to such components. In certain embodiments, the remote user interface 16 can forward status information concerning components located in the air compressor system enclosure 14 to the controller 70 in the welding machine. For example, if the air compressor lubricating oil is due to be changed (e.g., based on running hours or change in oil quality), the remote user interface 16 can inform the controller 70 of such a condition. The controller 70 can then generate an alarm to notify an operator via the local user interface 22. In certain embodiments, the controller 70 can prohibit operation of the air compressor 32 or other accessories based on the status information received from the remote user interface 16.

As discussed above, the welding machine 18 can include an air compressor 32 mounted within the engine-generator enclosure 12 and/or to the chassis structure base of the engine-generator, exterior to the enclosure. Conduits, such as supply and return lines 36a, 36b and a scavenge line 72 and a wiring harness 48 extend between the engine-generator enclosure 12 and the air compressor system enclosure 14. Air compressor system components such as the lubricating oil separator tank 34, coalescing filter 40, aftercooler 42 and aftercooler fan 44, and the oil filter 38 can be located in the air compressor system enclosure 14, to provide ready access to such components. As shown schematically in FIG. 4, the air compressor 32 can be driven directly by the engine 50 or by the generator 52.

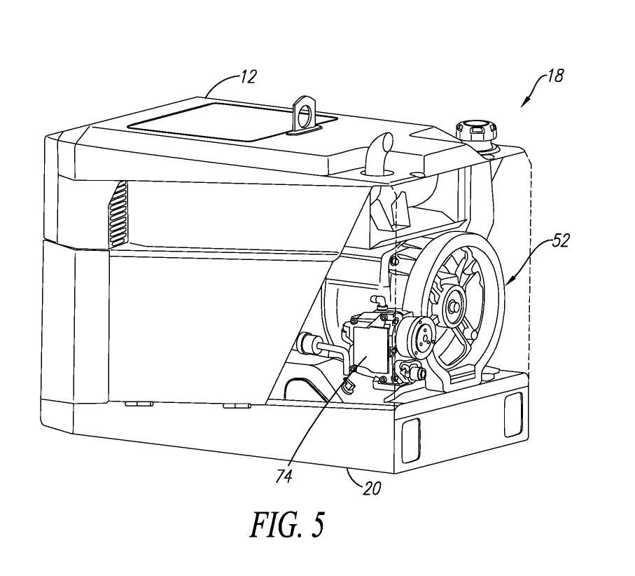

The welding machine 18 can include a pump 74 located within the engine-generator system enclosure 12, or otherwise supported by the chassis structure base of the welding machine. The pump 74 can be driven directly by the engine 50 or powered by the generator 52 via an electric motor. The drive system for the pump 74 can include a clutch (e.g., an electromagnetic clutch) that controls the application of torque to the pump, to selectively activate and deactivate the pump. Example pumps include hydraulic pumps and water pumps. The pump 74 is also shown in FIG. 5 mounted just above the chassis structure base 20.

If the pump 74 is a water pump, the multifunction engine-driven generator system can function as an emergency power source having water removal capabilities to address both flooding issues and loss of normal utility power, such as may occur during a storm. In certain embodiments, the speed of the pump can be controlled to maintain a particular flow rate, to avoid cycling the pump or engine on and off. The engine-generator system can include appropriate controls, such as engine speed controls, to operate the pump at a correct speed to achieve the desired flow rate. Pump activation along with a speed and/or flow setting can be controlled from one or both of the user interfaces 16, 22. The multifunction engine-driven generator system can include sensors for controlling the operation of the pump 74, such as float switches, pressure sensors, flow sensors, etc.

In certain embodiments, the multifunction engine-driven generator system can include a network interface 76 for communicating over a wired or wireless network. In one example, the network interface 76 can be a communication interface configured to communicate data to and/or from the welding machine 18. The network interface 76 can include various wired or wireless interfaces or connection ports. For instance, the network interface 76 can include video ports, serial ports, parallel ports, USB ports, or other communication ports. The network interface 76 can also include a wireless interface to enable communications via a wireless protocol such as WiFi or other wireless LAN protocol; Bluetooth, Wireless USB, or other similar RF protocol; a cellular radio protocol; an infrared protocol; or the like.

If the multifunction engine-generator is to be used outdoors when exposed to rain or snow, the auxiliary power receptacles can include weatherproof outlet covers that are weatherproof in-use, to seal against a power cord of an auxiliary load. As noted above, the auxiliary power receptacles can be GFCI receptacles.

The multifunction electric power generation systems discussed above could be part of a rental fleet, and users or customers that rent the multifunction electric power generation systems may not want to utilize each of the available accessories or power sources in the machine. For example, a customer may want to use an air compressor in the machine, but not a hydraulic or water pump. To provide flexibility, a rental company may wish to charge different rates to customers depending on which accessories are to be used. The rental company may charge a lower rate if only the generator or generator and welding power supply are to be used, and a higher rate if the generator and air compressor or pump are to be used. The electric power generation system can be configured to allow certain accessories to be selectively enabled or disabled. For example, if the customer purchases use of only the generator and welding power supply, then the air compressor and pumps can be disabled. Enabling and disabling the operation of accessories can be done through the user interfaces discussed above. A key or passcode may be required for enabling or disabling accessories. Enabling and disabling the operation of accessories can also be done remotely using wireless communications with the machine, or through a smart phone application upon payment to the rental company of a corresponding charge.

It should be evident that this disclosure is by way of example and that various changes may be made by adding, modifying or eliminating details without departing from the fair scope of the teaching contained in this disclosure. The invention is therefore not limited to particular details of this disclosure except to the extent that the following claims are necessarily so limited.

What is claimed is:

1. A vehicle-mounted electric power generation system, comprising:
an engine-generator enclosure;
an internal combustion engine located within the engine-generator enclosure;
an electric generator located within the engine-generator enclosure and coupled to the internal combustion engine and driven by the internal combustion engine;
an air compressor located within the engine-generator enclosure and driven by at least one of the internal combustion engine and the electric generator;
an air compressor system enclosure;
at least one of an air compressor lubricating oil separator tank, an air compressor lubricating oil filter, an aftercooler, and a coalescing filter, wherein said at least one of the air compressor lubricating oil separator tank, the air compressor lubricating oil filter, the aftercooler, and the coalescing filter is located within the air compressor system enclosure;
a compressed air conduit extending between the engine-generator enclosure and the air compressor system enclosure for conveying compressed air and air compressor lubricating oil from the air compressor; and
an air compressor lubricating oil conduit extending between the engine-generator enclosure and the air compressor system enclosure for supplying the air compressor lubricating oil to the air compressor.

2. The vehicle-mounted electric power generation system of claim 1, wherein the air compressor is a rotary screw compressor.

3. The vehicle-mounted electric power generation system of claim 2, wherein the coalescing filter is located within the air compressor system enclosure, and the system further comprises an oil scavenge line extending between the coalescing filter and the air compressor.

4. The vehicle-mounted electric power generation system of claim 1, wherein the aftercooler is located within the air compressor system enclosure, and the system further comprises an electrical power conductor extending between the engine-generator enclosure and the air compressor system enclosure, wherein an aftercooler fan is powered by the electric generator via the electrical power conductor.

5. The vehicle-mounted electric power generation system of claim 1, further comprising a vehicle-mounted user interface located remote from the both of the engine-generator enclosure and the air compressor system enclosure, wherein the user interface includes an activation input for activating the air compressor, and a pressure output for displaying air pressure of the compressed air.

6. The vehicle-mounted electric power generation system of claim 1, further comprising a water pump located within the engine-generator enclosure and driven by at least one of the internal combustion engine and the electric generator.

7. The vehicle-mounted electric power generation system of claim 1, further comprising a welding power supply located within the engine-generator enclosure and powered by the electric generator, wherein the welding power supply is configured to generate a welding waveform.

8. A vehicle-mounted electric power generation system, comprising:
an engine-generator enclosure;
an internal combustion engine located within the engine-generator enclosure;
an electric generator located within the engine-generator enclosure and coupled to the internal combustion engine and driven by the internal combustion engine;
an air compressor located within the engine-generator enclosure and driven by at least one of the internal combustion engine and the electric generator;
an air compressor system enclosure;
an air compressor lubricating oil filter located within the air compressor system enclosure;
a coalescing filter located within the air compressor system enclosure;
a compressed air conduit extending between the engine-generator enclosure and the air compressor system enclosure for conveying compressed air and air compressor lubricating oil from the air compressor; and
an air compressor lubricating oil conduit extending between the engine-generator enclosure and the air compressor system enclosure for supplying the air compressor lubricating oil to the air compressor.

9. The vehicle-mounted electric power generation system of claim 8, further comprising a lubricating oil separator tank located within the air compressor system enclosure.

10. The vehicle-mounted electric power generation system of claim 9, further comprising an oil scavenge line extending between the coalescing filter and the air compressor.

11. The vehicle-mounted electric power generation system of claim 9, further comprising an aftercooler comprising a fan located within the air compressor system enclosure, wherein the fan is powered by the electric generator.

12. The vehicle-mounted electric power generation system of claim 8, further comprising a vehicle-mounted user interface located remote from the both of the engine-generator enclosure and the air compressor system enclosure, wherein the user interface includes an activation input for activating the air compressor, and a pressure output for displaying air pressure of the compressed air.

13. The vehicle-mounted electric power generation system of claim 8, further comprising a water pump located within the engine-generator enclosure and driven by at least one of the internal combustion engine and the electric generator.

14. The vehicle-mounted electric power generation system of claim 8, further comprising a welding power supply located within the engine-generator enclosure and powered by the electric generator, wherein the welding power supply is configured to generate a welding waveform.

15. A multifunction electric power generation system, comprising:
an engine-generator enclosure supported by chassis structure base;
an internal combustion engine located within the engine-generator enclosure;
an electric generator supported by the chassis structure base and coupled to the internal combustion engine and driven by the internal combustion engine;
an air compressor supported by the chassis structure base and driven by at least one of the internal combustion engine and the electric generator;
a welding power supply located within the engine-generator enclosure and powered by the electric generator;
an air compressor system enclosure;
an aftercooler located within the air compressor system enclosure;
an air compressor lubricating oil filter located within the air compressor system enclosure;
a compressed air conduit extending between air compressor and the air compressor system enclosure for conveying compressed air and air compressor lubricating oil from the air compressor; and
an air compressor lubricating oil conduit extending between the air compressor and the air compressor system enclosure for supplying the air compressor lubricating oil to the air compressor.

16. The multifunction electric power generation system of claim 15, wherein the air compressor is a rotary screw compressor.

17. The multifunction electric power generation system of claim 15, wherein the aftercooler comprises an aftercooler fan powered by the electric generator.

18. The multifunction electric power generation system of claim 15, further comprising a vehicle-mounted user interface located remote from the both of the engine-generator enclosure and the air compressor system enclosure, wherein the user interface includes an activation input for activating the air compressor, and a pressure output for displaying air pressure of the compressed air.

19. The multifunction electric power generation system of claim 15, further comprising an oil scavenge line extending between the air compressor and the air compressor lubricating oil filter.

20. The multifunction electric power generation system of claim 15, further comprising a water pump located within the engine-generator enclosure and driven by at least one of the internal combustion engine and the electric generator.
